(19) United States
(12) Patent Application Publication
(10) Pub. No.: US 2017/0201574 A1
(43) Pub. Date: Jul. 13, 2017

(54) METHOD, SYSTEM, AND DEVICE FOR ALLOCATING RESOURCES IN A SERVER

(71) Applicant: Alibaba Group Holding Limited, George Town (KY)

(72) Inventor: Ben Luo, Hangzhou (CN)

(21) Appl. No.: 15/402,026

(22) Filed: Jan. 9, 2017

(30) Foreign Application Priority Data
Jan. 11, 2016 (CN) 201610016718.9

(51) Int. Cl. H04L 29/08; H04L 12/911; H04L 12/46

(52) U.S. Cl. CPC H04L 67/1031; H04L 12/4641; H04L 47/70

(57) ABSTRACT

Embodiments of the present application relate to a method, device, and system for allocating resources in a server. The method includes obtaining first resource usage information associated with the first host computing system and second resource usage information associated with the second host computing system, computing a first characteristic value and a second characteristic value, wherein the first characteristic value is computed based at least in part on the first resource usage information, the second characteristic value is computed based at least in part on the second resource usage information, obtaining a first comparison result based on comparing the first characteristic value to a resource usage threshold value of the first host, and a second comparison result based on comparing the second characteristic value to a resource usage threshold value of the second host computing system, and adjusting resource allocations for the first host computing system or the second host computing system.

### CROSS REFERENCE TO OTHER APPLICATIONS

This application claims priority to People's Republic of China Patent Application No. 201610016718.9 entitled A METHOD AND A DEVICE FOR SERVER RESOURCE ADJUSTMENT filed Jan. 11, 2016 which is incorporated herein by reference for all purposes.

### FIELD OF THE INVENTION

The present application relates to the field of server data processing. In particular, the present application relates to a method, device, and system for server resource adjustment.

### BACKGROUND OF THE INVENTION

Cloud computing, a new Internet-based approach to computing, has already been broadly applied in various fields. The use of cloud computing enables shared hardware and software resources and information to be provided to computers and other equipment as needed. A cloud computing provider according to the conventional art often provides general online business applications (e.g., software-as-a-service), which can be accessed through software, such as browsers or other Web services, and both the software and data are stored on the server. The problem of how to control the service quality and cost of cloud computing has received increasing attention. The conventional art uses a control method that focuses on determining the resource allocation ratios of different hosts in a server, (i.e., the problem of server resource allocation).

In the conventional art, static configuration is often implemented first, and then resources are allocated to different hosts according to the content of the static configuration. The static configuration can be the traditional Cgroup configuration by a config file (e.g., /etc/cgconfig.conf for redhat Linux). However, online business scenarios vary tremendously. Because of the dynamic nature of online business scenarios (e.g., online business applications), determining a perfect static configuration scheme in advance that would achieve optimal allocation of resources is generally not possible. Because the existing static configuration scheme is very unlikely to achieve optimal allocation of resources, use of a static configuration of resource allocation (e.g., resource allocation by cgroup can set the resource limitation) in connection with controlling resource allocation inevitably tends to result in resource wastage and thus severely affects service quality and stability.

According to the conventional art, if it becomes necessary to adjust resource allocation for the current hosts (e.g., servers such as physical servers or virtual servers), then generally the adjustments to resource allocations are made manually. A manual configuration adjustment scheme is generally ineffective and inefficient because such a scheme cannot affect adjustments promptly in response to online load variations. Furthermore, the granularity of manual adjustments often is such that their units consist of groups. If adjustments are made with a granularity of independent hosts, the cost will be unacceptable. In particular, the risks associated with online manual operations are very large and involve the more complex permission management.

### BRIEF DESCRIPTION OF THE DRAWINGS

Various embodiments of the invention are disclosed in the following detailed description and the accompanying drawings.

FIG. 1 is a flowchart of a method for server resource adjustment according to various embodiments of the present application.

FIG. 2 is a flowchart of a method for server resource adjustment according to various embodiments of the present application.

FIG. 3 is a structural block diagram of a device for server resource adjustment according to various embodiments of the present application.

FIG. 4 is a structural schematic diagram for server resource adjustment according to various embodiments of the present disclosure.

FIG. 5 is a functional diagram of a computer system for server resource adjustment according to various embodiments of the present disclosure.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

To make the above-described objectives, features, and advantages of the present application plainer and easier to understand, the present application is explained in further detail below in light of the drawings and specific embodiments.

According to various embodiments, various operational scenarios are adapted based at least in part on using background processes on a server to obtain (e.g., collect) resource usage information and correspondingly to adjust resource allocations. Adjusting the corresponding resource allocation based at least in part on the resource usage information can result in an efficient allocation of resources and an optimal configuration of resources. According to various embodiments, resource usage allocations include one or more configurations associated with memory, memory usage, CPU usage, CPU cycles, I/O, and network bandwidth.

As used herein, a terminal generally refers to a device used (e.g., by a user) within a network system and used to communicate with one or more servers. According to various embodiments of the present disclosure, a terminal includes components that support communication functionality. For example, a terminal can be a smart phone, a tablet device, a mobile phone, a video phone, an e-book reader, a desktop computer, a laptop computer, a netbook computer, a personal computer, a Personal Digital Assistant (PDA), a Portable Multimedia Player (PMP), an mp3 player, a mobile medical device, a camera, a wearable device (e.g., a Head-Mounted Device (HMD), electronic clothes, electronic braces, an electronic necklace, an electronic accessory, an electronic tattoo, or a smart watch), a smart home appliance, vehicle-mounted mobile stations, or the like. A terminal can run various operating systems.

As used herein, a host is a hypervisor in virtual machine systems. For example, the host can refer to a hypervisor that includes one or more virtual machines (e.g., running thereon). The host can be the virtualization platform on which one or more virtual machines are running.

As used herein, a virtual machine is a virtualization that runs on a host. A plurality of virtual machines can run on a single host. The plurality of virtual machines running on a host can share resources of the host such as memory, CPU capacity, etc.

A server is a computing device that is connected to a network and that provides an application or a service to one or more users (e.g., via clients). In some embodiments, a server comprises one or more hosts and/or one or more virtual machines. A server can mean a combination of software and hardware (e.g., a physical machine) to provide services via the Internet to endpoint users. The host is a concept in virtualization and can represent a hypervisor or virtualization platform on which one or more virtual machines can run. For example, a host can correspond to a physical server or a virtual server. In some embodiments, a host can be an instance running on a physical server. As used herein, a host can refer to a host computer. The server can comprise a various number of hosts or virtual machines. A server can be a terminal.

A terminal can have various input modules. For example, a terminal can have a touchscreen, one or more sensors, a microphone via which sound input (e.g., speech of a user) can be input, a camera, a mouse or other external input device connected thereto, etc.

As used herein, a first host computing system can refer to a host computer, and a second host computing system can refer to one or more virtual machines (e.g., one or more virtual machines running on the first host computing system).

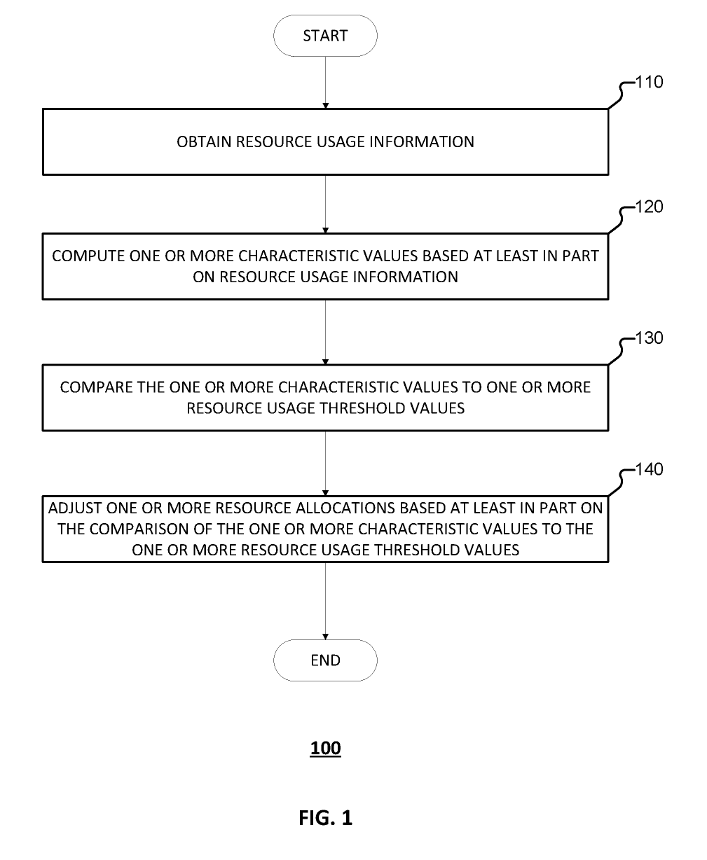

FIG. 1 is a flowchart of a method for server resource adjustment according to various embodiments of the present application.

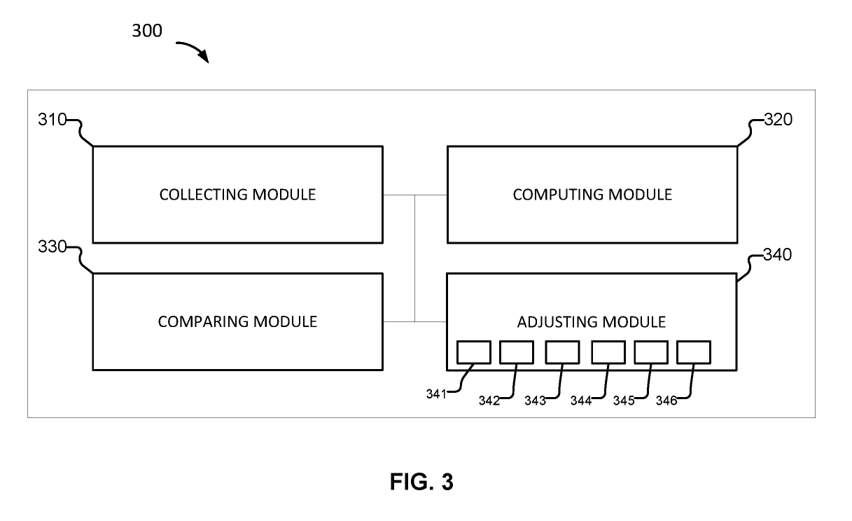

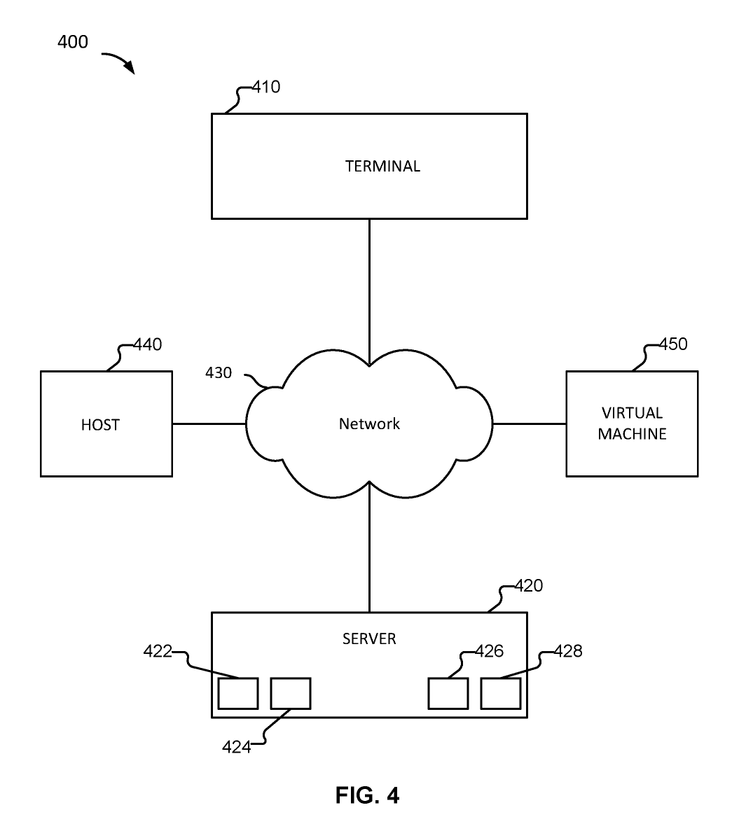

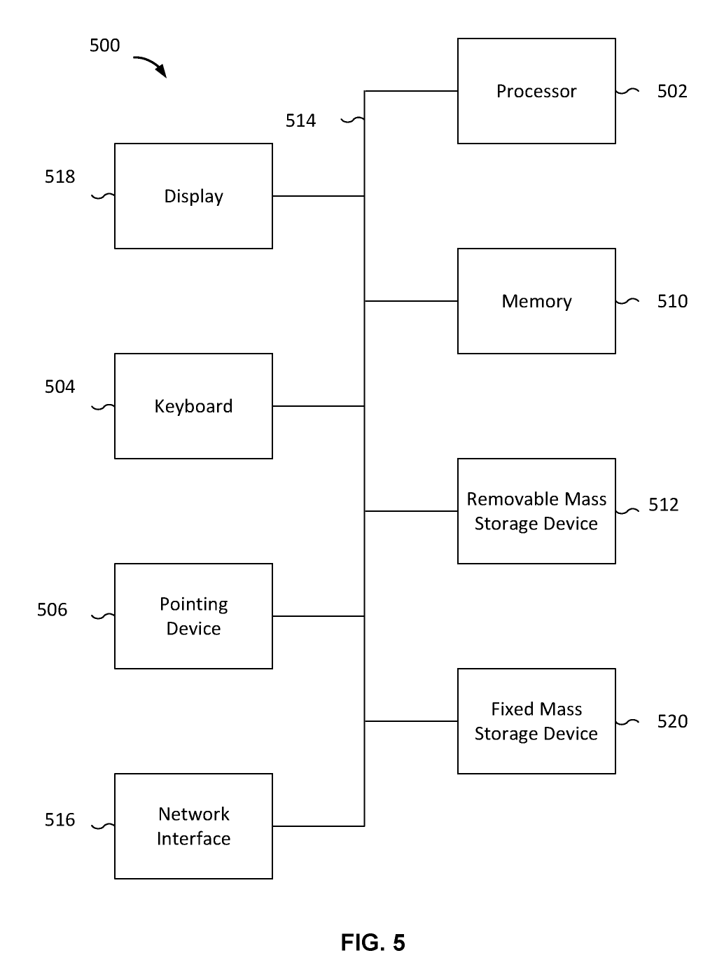

Referring to FIG. 1, process 100 for resource adjustment is provided. Process 100 can be implemented by device 300 of FIG. 3, system 400 of FIG. 4, and/or computer system 500 of FIG. 5.

At 110, resource usage information is obtained. A server can obtain (e.g., collect) resource usage information for one or more hosts. For example, a background service can be run in the host service process (e.g., a process run on the host) and the host service process can collect resource usage information for the corresponding host. Each host can have a corresponding process that collects resource usage information for that specific host. The process that collects resource usage information can be run on a different server than the server on which the host is running. The one or more hosts can individually or collectively provide an application. The application can be provided over a network such as, for example, the Internet and/or a private network, thus delivering the application to the end user in a software-as-a-service model. The server can obtain first resource usage information associated with a first host computing system (e.g., information indicating a resource usage of the first host computing system) and second resource usage information associated with a second host computing system (e.g., information indicating a resource usage of the second host computing system). The resource usage information can be obtained according to a preset sampling frequency. The preset sampling frequency can be configured by a user or an administrator such as an administrator of a business application being operated on the server (e.g., by one or more hosts associated with the server). In some embodiments, the resource usage information is obtained in response to the occurrence of one or more predefined events.

According to various embodiments, the server can obtain the resource usage information for one or more hosts via a background process running on the server or the hosts associated with the resource usage information. For example, while the server is running, a background process(es) running on the first host computing system collects resource usage data associated with the first host computing system, and a background process(es) on the second host computing system collects resource usage data associated with the second host computing system. The background processes can collect the corresponding resource usage data at a certain sampling frequency.

In some embodiments, the resource usage information includes information associated with one or more of memory, CPU cycles, I/O, network bandwidth, and/or other appropriate resources. The resource usage information associated with a host can comprise resource use data for the host's process groups. The resource usage information associated with a virtual machine can comprise resource use data for the virtual machine's process groups.

At 120, one or more characteristic values are computed based at least in part on resource usage information. A characteristic value can indicate how the resource is used or a normalized measurement of a usage or a particular resource. The server can compute the one or more characteristic values. In some embodiments, a characteristic value can be computed for a corresponding resource usage information. For example, a first characteristic value can be computed based at least in part on first resource usage information such as CPU usage. CPU usage (e.g., CPU memory usage) can be collected by using one or more system tools of a host operating system. As another example, a second characteristic value can be computed based at least in part on the second resource usage information such as memory usage. The one or more characteristic values can be computed according to preset adjustment frequencies. For example, the one or more characteristic values can be computed at predefined interval(s) of time. In some embodiments, a preset adjustment frequency with which the one or more characteristic values are computed is lower than the preset sampling frequency (e.g., according to which the resource usage information is obtained). In some embodiments, the one or more characteristic values are computed in response to the occurrence of one or more predefined events. A predefined event can be an indication that the CPU usage exceeds one or more thresholds. For example, CPU usage of 80% (e.g., a CPU usage of 80% of total CPU capacity).

At 130, at least one of the one or more characteristic values is compared to one or more corresponding resource usage threshold values. The server can compare the one or more characteristic values to the one or more corresponding resource threshold values. In some embodiments, the first characteristic value is compared to a first preset resource usage threshold value associated with the first host computing system to obtain a first comparison result, and/or the second characteristic value is compared to a second preset resource usage threshold value associated with the second host computing system to obtain a second comparison result. The resource usage threshold value can be set by a user such as an administrator. The resource usage threshold value can be set based at least in part on one or more safety reasons, or based on a performance of a system. For example, the resource usage threshold value can be set according to a usage ratio beyond which a system experiences a system crash. The resource usage threshold value can be set based at least in part on historical information relating to resource usage or system performance. In some embodiments, the first preset resource usage threshold value is different from the second preset resource usage threshold value. In some embodiments, the first preset resource usage threshold value is the same as the second preset resource usage threshold value. Each characteristic value computed based on resource usage information can be compared to a corresponding resource usage threshold.

At 140, resource allocations associated with one or more hosts are adjusted. Resource allocations that can be adjusted can include CPU processing or memory allocations, bandwidth, storage, or the like. For example, for a resource of CPU time, CPU time is allocated among virtual machines and the processes on the corresponding host, and each process or virtual machine can only use up its own quota (e.g., allocation) of CPU time. The resource allocations associated with the one or more hosts are respectively adjusted based at least in part on the comparison of the one or more characteristic values to the one or more resource usage threshold values. For example, resource allocations associated with the first host computing system are adjusted based at least in part on the first comparison result and/or resource allocations associated with the second host are adjusted based on the second comparison result. In some embodiments, the server adjusts the resource allocations. The server can save the adjusted resource allocations to a local storage or to a remote storage to which the server is connected via a network.

Various embodiments use a first preset host resource usage threshold value (associated with the first host computing system) and a second preset host resource usage threshold value (associated with the second computing system) in connection with adjusting resource allocations. The server can adjust resource allocations in connection with providing one or more business applications. While the server is running, background processes running on the first host computing system collect first host computing system resource use data at a certain sampling frequency and background processes running on the second host collect the second computing system resource use data at a certain sampling frequency. Then, the characteristic values respectively associated with the first host computing system and second computing system resource usage data (e.g., the first characteristic value and the second characteristic value) are computed separately in accordance with a preset adjustment frequency based on the corresponding resource usage data (e.g., first host computing system resource usage data and second computing system resource usage data). Based on the computed one or more characteristic values (e.g., the first characteristic value and the second characteristic value), the resource configuration of the server is dynamically adjusted. For example, as the one or more characteristic values are computed according to a preset frequency or at preset time intervals, the host is notified to increase or decrease the ratio of CPU allocated to run various virtual machines according to characteristic values pertaining to CPU usage. As an example, the number of CPU cgroup configuration changes can be adjusted according to one or more characteristic values and/or one or more host resource usage threshold value to achieve an appropriate resource allocation. A cgroup can be configured to limit a certain process(es) to only be run on some CPU. If the CPU utilization of such processes is too high, the CPU number is deemed to be relatively insufficient, and the original cgroup configuration is adjusted accordingly to allocate such processes a greater number of CPU resources. The process(es) can include the host virtual machine process (e.g., the virtual machine in the host can be deemed to be a process). The importance of different processes and the resource allocation to such processes, such as virtual machine processes, affect not only the user experience, but can also affect performance of the entire system process (e.g., if the CPU is likely to lead to the entire system crash). According to various embodiments, online resource adjustment of the server is performed in a completely self-adaptive manner; the resource adjustment can fully adapt to various business scenarios.

Various embodiments are described in the context of an example in a Kernel-based Virtual Machine (KVM) virtualization in order to provide a detailed explanation. KVM is an open-source system virtualization module. KVM is a Linux kernel module used in connection with virtualization. As used herein, KVM server means a physical machine installed with KVM module, and the virtual machines that run on the KVM server can be called KVM virtual machines. KVM uses Linux's native scheduler to carry out management. KVM's virtualization generally requires hardware support (such as chips implementing Intel® Virtualization Technology or AMD®-Virtualization).

An important advantage to virtualization is the ability to consolidate multiple workloads onto a single computer system. Such consolidation is able to conserve electrical power and save on costs and administrative expenses. The extent of savings is determined by over-use of hardware resources, such as memory, CPU cycles, I/O, and network bandwidth. However, over-use must be carried out under conditions of assured security and service quality. Therefore, it becomes necessary to partition and isolate the resources seized by the host and virtual machines.

In the event of a KVM virtualization, control groups (also referred to herein as Cgroups) generally are used to isolate virtual machine and host resources. That is, according to conventional art, a static Cgroups strategy is generally used to limit resources on KVM host computers. The isolation of resources according to a static configuration necessarily sacrifices flexibility in relation to resource sharing.

In a KVM virtualization architecture, a virtual machine includes an operating entity formed by combining Quick Emulator (QEMU) processes (e.g., a main thread and one or more vcpu threads) and kernel threads such as vhost-net. Without imposing any limits, these threads and other threads on the host (including system threads and application threads) tend to generate competitive relationships. Such competition among processes and threads can affect service quality, which under extreme circumstances causes some critical service processes to be killed or causes the host to crash.

In the event of competition among processes and threads competing in such a manner that service quality is adversely affected, if the priority levels of the host processes are raised without understanding the applicable context of the processes and threads, or of the hosts, or the business applications being provided, the result will be a severe drop in virtual machine quality of service (QoS). In order to cure the adverse effect on service quality resulting from competition among processes and threads, priorities can be configured for hosts (e.g., on a host-by-host basis) or for processes (e.g., on a process-by-process basis) to ensure that critical processes on the host have sufficient resources (e.g., CPU resources, memory resources, etc.) for safe operation, while also providing the highest possible QoS to the virtual machine. Therefore, according to various embodiments, server resources are isolated according to one or more ratios. Cgroups can be used to isolate computer resources. In some embodiments, quota ratios (e.g., one or more ratios according to which the server resources are isolated based on the use of a Cgroups strategy for isolating computer resources) can use empirical values or reference values obtained according to test data under certain load models. As an example, resources like CPUs are shared by all processes running in the host. Some processes are integral or important to system operation safety and, as a result, such processes should be allocated a quota of CPU usage that ensures that the system does not hang for lack of CPU resources. For example, allocation of resources can be configured using the quota ratios in connection with obtained resource usage information. One or more thresholds that are used in connection with the quota ratios to allocate resources can be determined based on historical information associated with resource usage information.

According to conventional art, a static Cgroups strategy is employed for restricting resources on a KVM host (e.g., a virtualization platform that provides virtual machines as services). However, the application types (e.g., load models) of different users (or of different applications running on the server, hosts, or instances) vary, resulting in very large differences in usage demands for different resources. Adjusting the strategy of resource allocation for each and every host in a cluster is burdensome, ineffective, and generally not possible. Static strategy adjustments are generally based on mean values for an entire cluster of machines over a period of time. The granularity of overall adjustments according to mean values computed in the context of an entire cluster is too coarse and cannot cope with the load characteristics of the individual hosts.

According to various embodiments, one or more common resource allocation strategies are determined. The one or more common resource allocation strategies are issued to (e.g., provided to) different host groups (e.g., host computer groups). The virtual machine resource usage can be determined and a live migration technology can be used (e.g., based at least in part on the virtual machine resource usage types) to migrate the different virtual machine resources to different host groups. It is thus possible to dynamically ensure service quality by using live migration technology; however, the use of live migration technology to allocate resources across hosts cannot maximally optimize resource utilization rates. Moreover, the limitations of live migration technology are considerable and thus live migration technology is thus not ideal for commercialization. For example, the live migration process generally unavoidably leads to a service suspension for a certain period of time. In addition, pre-determined resource allocation strategies are often rather crude and lack online dynamic adjustments that are better suited to the rapidly changing load conditions online. Furthermore, determining sizes of the different resource groups is difficult in deployment of the live migration technology for allocating resources across hosts. A new allocation imbalance may very well result.

Therefore, if the above technology according to the conventional art (e.g., the live migration technology) is used to adjust server resources while under KVM virtualization, the following problems will likely continue to exist: First, response latency will increase. A struggle over resources may often arise, and such a resource struggle will not be discovered until long after user experience has suffered and only then will it be possible to make new adjustments. Second, adjustment granularity will be too coarse. Targeted decisions cannot be made for individual host load characteristics. Thus, resource waste and diminished user experiences tend to be the result. Third, adjustments will need to be made manually, which takes time and effort. Consequently, there will be greater operating risks and additional cost of permission management.

In addressing the problem above, various embodiments monitor resource usage and correspondingly adjust resource allocations. Various embodiments are adapted to various business scenarios by using background processes on a server to collect resource usage information and correspondingly to adjust resource Cgroups settings, thus achieving an efficient (e.g., optimal) configuration of resources.

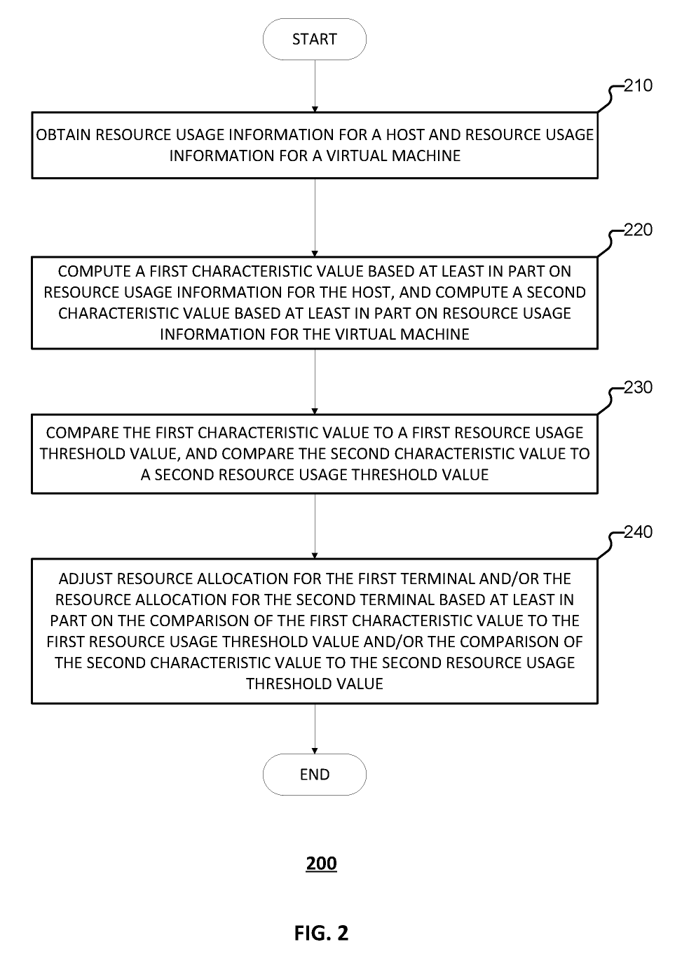

FIG. 2 is a flowchart of a method for server resource adjustment according to various embodiments of the present application.

Referring to FIG. 2, process 200 for resource adjustment is provided. Process 200 can be implemented by device 300 of FIG. 3, system 400 of FIG. 4, and/or computer system 500 of FIG. 5.

At 210, resource usage information is obtained. A server can obtain (e.g., collect) resource usage information for one or more hosts. For example, a background service can be run in the host service process (e.g., a process run on the host) and the host service process can collect resource usage information for the corresponding host. Each host can have a corresponding process that collects resource usage information for that specific host. The process that collects resource usage information can be run on a different server than the server on which the host is running. In some embodiments, resource usage information can be collected by reading the system's proc file, or by using a similar Top, mpstat, vmstat, pidstat and other software. The one or more hosts can individually or collectively provide a business application. The application can be provided over a network such as, for example, the Internet and/or a private network, thus delivering the application to the end user in a software-as-a-service model. The server can obtain first resource usage information associated with a host (e.g., information indicating a resource usage of the host) and second resource usage information associated with a virtual machine (e.g., information indicating a resource usage of the virtual machine). The resource usage information can be obtained according to a preset sampling frequency. The preset sampling frequency can be configured by a user or an administrator such as an administrator of a business application being operated on the server (e.g., by one or more hosts associated with the server). In some embodiments, the resource usage information is obtained in response to the occurrence of one or more predefined events.

According to various embodiments, the server can obtain the resource usage information for one or more hosts or virtual machines via a background process running on the server, or the hosts or virtual machines associated with the resource usage information. For example, while the server is running, a background process(es) running on the host collects the resource usage data associated with the host and/or one or more virtual machines running on the host. In a KVM virtualization, the virtual machine in the host can be a qemu process. In some embodiments, a background process(es) on the virtual machine collects the resource usage data associated with the virtual machine. The background process can be a custom-implemented process. For example, the background processes can be a process that reads the corresponding resource usage data from log files at a certain sampling frequency.

In some embodiments, the resource usage information includes information associated with one or more of memory, CPU cycles, I/O, and network bandwidth.

In some embodiments, resource usage information associated with a host and/or resource usage information associated with a virtual machine is collected according to a preset frequency f (e.g., once every 5 s).

Various embodiments provide dynamic allocation of server resources based at least in part on Cgroups technology. KVM is a type of virtualization technology that configures a Linux kernel into a hypervisor, with a virtual machine running as a process on the Linux operating system (e.g., on the Linux kernel). The KVM is a kernel module, and the installation of the kernel module on the Linux operating system can be called KVM virtualization platform. For example, the installation of the KVM on the Linux operating system can be a KVM hypervisor. The KVM hypervisor can run a virtual machine as a process. KVM virtualization leverages the infrastructure of many Linux operating systems, such as the use of cgroups for resource constraints. Linux uses cgroup for resource constraints to single or multiple processes (e.g., to limit the use of resources such as CPU utilization, memory usage, or the like). Because the virtual machine is a process running on the host, the cgroup can be used in connection with allocating resources (e.g., enforcing resource usage limits) to virtual machines. Cgroups is a Linux core function used to restrict, control and separate the resources of a process group (such as CPU, memory, disk input/output, etc.). The Cgroups mechanism to manage resources, thus controlling the physical resources available to each KVM and reporting CPU utilization rates, CPU cores, memory or the like. A control group corresponds to a group of processes defined according to a certain standard. Resource control in Cgroups is achieved using control groups. According to various embodiments, a process is added (e.g., assigned) to a certain control group. In some embodiments, a process is migrated from one process group to another control group. For example, the process can be moved from one control group to another control group. In some embodiments, the process can be shut down in a first control group and then restarted in a second control group. In some embodiments, the process can be reassigned from the first control group to the second control group. The Linux operating system (e.g., the host) can use Cgroups to allocate resources at the level of the control group. For example, the Cgroups can be used to make assignments for resources for control groups. At the same time, the processes in the process group are subject to restrictions set by Cgroups at the level of the control group.

According to various embodiments, Cgroups on a host are used to group virtual machine processes and host processes separately.

The resource usage information associated with a host can be resource usage data for the host's process groups. The host process groups comprise the relevant process groups that provide services to the entire virtual machine. In some embodiments, the host processes mainly comprise host operating system critical processes and any relevant processes that provide services to virtual machines.

The resource usage information associated with a virtual machine can comprise resource use data for the virtual machine's process groups. The virtual machine process groups are process groups for the virtual machine itself. In some embodiments, the host processes primarily comprise the processes of the virtual machines themselves.

According to various embodiments, it is possible to collect from designated files of the host the resource use data for the host process groups and the resource use data for the virtual machine process groups according to a preset sampling frequency. For example, the designated files can be corresponding process statistics files in the /proc portion of the file system of the host.

Of course, a person skilled in the art may use any method to collect resource usage information for the host and virtual machines. The present application imposes no restrictions in this regard.

At 220, a first characteristic value is computed and a second characteristic value is computed. The first characteristic value and/or the second characteristic value can be computed by a server. In some embodiments, the first characteristic value is computed based at least in part on resource usage information associated with the host, and the second characteristic value is computed based at least in part on resource usage information associated with the virtual machine. The first characteristic value and/or the second characteristic value can be computed according to a preset adjustment frequency or a preset adjustment time interval.

In some embodiments, the preset adjustment frequency used to compute the first characteristic value and/or the second characteristic value is lower than the sampling frequency used in connection with obtaining (e.g., collecting) the resource usage information at 210. For example, sampling can be performed once a second, and adjustments can be made once every ten seconds, with 10 samples of usage data as referencing. For example, the resource usage information associated with the host and the resource usage information associated with the virtual machine can be obtained (e.g., collected) at frequency f (e.g., a frequency of once every 5 seconds (5 s)). The characteristic values (including first characteristic values and second characteristic values) for the previously collected resource usage information can be computed according to the preset adjustment frequency T (e.g., a frequency of once every 2 hours). For example, at 10:00, the characteristic values associated with the resource usage information collected from 8:00 to 10:00 are computed, and at 12:00, the characteristic values associated with the resource usage information collected from 10:00 to 12:00 can be computed.

In some embodiments, characteristic values can be computed (or determined) based at least in part on one or more sliding averages. For example, the sliding average of the resource usage information associated with the host can be computed, and the sliding average of the resource usage information associated with the virtual machine can be computed. The sliding averages can be computed according to preset adjustment frequencies.

It is generally known that sliding averages are the averages of multiple, continuous m-term series calculated from an n-term time series. According to the computation of sliding averages, the first term of the first continuous m-term series is the sum of the first term to the m-th term of the original n-term series divided by m; the second term of the second continuous m-term series is the sum of the second term to the (m+1)th term of the original n-term series divided by m; and so on; and the first term of the last m-term series is the (n−m+1)th term of the n series. The sliding averages have different names because of different term numbers m. For example, m is 1, 2, and 3. The sliding averages are referred to, respectively, as the 1 h sliding average, the 2 h sliding average, and the 3 h sliding average.

According to various embodiments, a single sampling result is not used as the basis for making a decision. Rather, the characteristic value of sample data (e.g., resource usage information) from a past time interval is used. The values (e.g., the characteristic values) that are thus computed carry historical information and will not be affected by momentary data spikes. Accordingly, a characteristic value computed based at least in part on a sliding average associated with the resource usage information can better reflect the resource usage situation. In addition, there is no need to store large amounts of sampled data in connection with determining a characteristic value computed based at least in part on a sliding average associated with the resource usage information.

Of course, the above scheme in which sliding averages served as characteristic values was merely used as an illustrative example. Persons skilled in the art may, in accordance with actual conditions, use any kind of characteristic value. For example, characteristic values can be determined based at least in part on weighted sliding averages of multiple prior time intervals, and/or by increasing the damping coefficient. The present application imposes no restrictions in this regard.

At 230, the first characteristic value is compared to a first resource usage threshold value, and the second characteristic value is compared to a second resource usage threshold value. In some embodiments, the server performs such comparisons. The first resource usage threshold value can correspond to a preset resource usage threshold value associated with the host. A first comparison result can be obtained (e.g., determined) based on the comparison of the first characteristic value with the first resource usage threshold value. The second resource usage threshold value can correspond to a preset resource usage threshold value associated with the virtual machine. A second comparison result can be obtained (e.g., determined) based on the comparison of the second characteristic value with the second resource usage threshold value.

The first comparison result can comprise results of the following situations: (i) the first characteristic value being greater than the first resource usage threshold value (e.g., the resource usage threshold value associated with the host); (ii) the first characteristic value being equal to the first resource usage threshold value (e.g., the resource usage threshold value associated with the host); (iii) the first characteristic value being less than the first resource usage threshold value (e.g., the computer resource usage threshold value associated with the host).

The second comparison result can comprise results of the following situations: (i) the second characteristic value being greater than the second resource usage threshold value (e.g., the resource usage threshold value associated with the virtual machine); (ii) the second characteristic value being equal to the second resource usage threshold value (e.g., the resource usage threshold value associated with the virtual machine); or (iii) the second characteristic value being less than the second resource usage threshold value (e.g., the resource usage threshold value associated with the virtual machine).

According to various embodiments, the first resource usage threshold value corresponds to an upper limit value of computer resource usage for the host (e.g., a limit on the permitted resource usage by the host), and the second resource usage threshold value corresponds to an upper limit value of resource usage for the virtual machines running on the host (e.g., a limit on the permitted resource usage by the virtual machine). For example, two resource usage warning lines for ensuring system safety (e.g., the first resource usage threshold value and the second resource usage threshold value) are separately set. In some embodiments, the host resource utilization rate may be controlled to keep the utilization rate as far as possible from the upper threshold value for host resource usage (e.g., the first resource usage threshold value) and the virtual machine resource utilization rate may be controlled to keep the utilization rate as far as possible from the upper threshold value for virtual machine resource usage (e.g., the second resource usage threshold value). To ensure that the resource usage by the host and the resource usage by the virtual machine are below the corresponding warning lines (e.g., the corresponding resource usage threshold values), resources are allocated (e.g., divided) between the host (e.g., processes on the host that are not for virtual machines running thereon) and the virtual machine. For example, the resources can be allocated according to the usage or requirements by the host and the virtual machine.

At 240, resource allocations associated with the hosts or virtual machine are adjusted. The resource allocations associated with the host and the virtual machine are respectively adjusted based at least in part on the comparison of the first or second characteristic values to the first resource usage threshold value and/or second resource usage threshold value, respectively. For example, the resource allocations for the host (e.g., host computer) and/or the virtual machine are adjusted based on the first comparison result and/or the second comparison result. As an example of resource allocation for CPU usage: if the host has 10 CPUs, the CPUs can be divided among host key processes and virtual machine processes based at least in part on the CPU usage statistic data; if the sum of the host key processes' CPU usage is 20%, and the virtual machines' CPU usage is 80%, the CPUs can be allocated by a ratio of 1:4 (e.g., 2 CPUs for host key processes and 8 CPUs for virtual machines).

In some embodiments, adjusting the resource allocations associated with the host and/or the virtual machine comprises, when the first comparison result that corresponds to the first characteristic value is less than the resource usage upper threshold value for host resource usage (e.g., the first resource usage threshold value), and the second comparison result that corresponds to the second characteristic value is less than the resource usage upper threshold value for virtual machine resource usage (e.g., the second resource usage threshold value), and if a first characteristic parameter is less than the second characteristic parameter by n times the smallest unit of resource usage (e.g., the smallest indivisible unit of resource usage data, such as 1 CPU), then setting the smallest unit resource usage by multiplying by (n/2+1) for the virtual machine process groups and the smallest unit resource usage by dividing by (n/2+1) for host process groups; or, if a second characteristic parameter is less than a first characteristic parameter by n times the smallest unit resource usage, then setting the smallest unit resource usage by dividing by (n/2+1) for the virtual machine process groups and the smallest unit resource usage by multiplying by (n/2+1) for the host process groups, wherein n is an integer and n/2 is rounded. The smallest unit of resource usage can correspond to the smallest indivisible resource adjustment unit. As an example, if a first characteristic value is A, a second characteristic value is B, and a total available resources is S, where A, B, and S are integers, then allocation can be determined as—allocation for first group: A/(A+B)*S, and allocation for second group: B/(A+B)*S.

To take the CPU utilization rate as an example, the resource usage upper threshold value for the host and the resource usage upper threshold value for the virtual machine are set in advance based on empirical measurements. In some embodiments, an application or process may run on the host as a background program. The application process can additionally or alternatively be run on the server or the virtual machine. The background program obtains (e.g., collects) resource usage information for a host (e.g., resource use data for host computer critical process groups) and resource usage information for the virtual machine (e.g., resource use data for virtual machine process groups). The background program can obtain the resource usage information at a preset frequency f (e.g., once every 5 s). At a preset time interval (e.g., two hours), the background program can calculate, respectively, the sliding average of the resource usage information for the host (e.g., resource use data for the previously collected host computer critical process groups) (“host computer sliding average”) and the sliding average of the resource usage information for the virtual machine (e.g., resource use data for virtual machine process groups) (“virtual machine sliding average”).

According to various embodiments, in the event that the host computer sliding average is less than the upper resource usage threshold value for the host resource usage and the virtual machine sliding average is less than the resource usage upper threshold value for the virtual machine resource usage, and if the host computer sliding average (e.g., the exponential damping sliding average for the CPU utilization rate (sample data) for host process groups) is n times the smallest unit of resource usage less than the virtual machine sliding average (e.g., the exponential damping sliding average for the CPU utilization rate (sample data) for virtual machine process groups), then the Cgroups restriction strategy is readjusted as follows: decrease the cpuset of the appropriate host process groups by n/2 of the smallest units of resource usage, and increase the cpuset of the virtual machine process groups by n/2 of the smallest units of resource usage.

In some embodiments, the Cgroups file system interface is called to perform dynamic updating of the new resource allocation (e.g., the new Cgroups restriction strategy).

In some embodiments, adjusting the resource allocations associated with the host and/or the virtual machine comprises, in the event that the first comparison result that corresponds to the first characteristic value is greater than or equal to the resource usage upper threshold value for the host, and/or the second comparison result that corresponds to the second characteristic value is greater than or equal to the resource usage upper threshold value for the virtual machine, extracting mutually exclusive virtual machine process groups and host process groups; and allocating resources from the mutually exclusive virtual machine process groups and host process groups. Extracting the mutually exclusive virtual machine process groups and host process groups means removing resource from what would otherwise be allocated to such process groups. In some cases, the allocation by the algorithm above can be dangerous, for example, in the event that the allocated resource may be not enough for the safety operating of host key processes. In those cases, embodiments can break from the principle to allocate extra resource for safety to the host key processes (e.g., extract resources from what was to belong to the virtual machines).

In some embodiments, adjusting the resource allocations associated with the host and/or the virtual machine comprises, in the event that the first comparison result that corresponds to the first characteristic value is greater than or equal to the resource usage upper threshold value for the host, and/or the second comparison result that corresponds to the second characteristic value is greater than or equal to the resource usage upper threshold value for the virtual machine, issuing an advance warning signal to the host, the virtual machine, the server, or an administrator of the business application. The advance warning signal can instruct the upper level control system to carry out live migration accordingly. In some embodiments, the advanced warning signal notifies that a reallocation of resources is to be performed. In cloud computing, all hosts are deemed the lower level infrastructure, and the upper level control system is a manager of those hosts. The manager of those hosts monitors the status of all hosts and in charge of deciding when and on which host a virtual machine can be started, and can issue a command to migrate (lively or statically) some virtual machines from one host to another host.

In some embodiments, in the event that the first comparison result that corresponds to the first characteristic value is greater than or equal to the resource usage upper threshold value for the host, and the second comparison result that corresponds to the second characteristic value is greater than or equal to the resource usage upper threshold value for the virtual machine, adjusting the resource allocations associated with the host and/or the virtual machine comprises suspending virtual machine process group resource allocation and maintaining host process group resource allocation.

In some embodiments, if it is discovered (e.g., determined) that there is any process group (e.g., a host process group or a virtual machine process group) that exceeds its preset resource usage upper threshold value, then an emergency response mode is activated immediately. In emergency response mode, resources are allocated from mutually exclusive process groups (e.g., virtual machine process groups or host process groups that do not share resources). For example, the resources allocated to one or more of the mutually exclusive process groups are reallocated to the process group that exceeds its preset resource usage upper threshold value. In some embodiments, selection of the one or more mutually exclusive process groups from which resources are reallocated to the process group that exceeds its preset resource usage upper threshold value can be selected based on respective priorities of the one or more mutually exclusive process groups, a respective resource usage by the one or more mutually exclusive process groups, a difference between a respective resource usage by the one or more mutually exclusive process groups in relation to a respective resource usage threshold, or the like.

In some embodiments, priority levels are set for the virtual machine process groups and host process groups, respectively. According to various embodiments, allocation of resources from the mutually exclusive virtual machine process groups and host process groups can comprise: determining the lowest-priority level virtual machine process groups or host process groups that can be allocated from among the mutually exclusive virtual machine process groups and host process groups; and seizing the virtual machine process groups or host process groups for resource allocation. For example, if a host process group exceeds the preset resource usage upper threshold value for the host (or the host process group), then resources are forcibly acquired (e.g., reallocated) from the lowest-priority virtual machine process group that is currently allocable. To forcibly acquire resources form the lowest-priority virtual machine includes to reallocate a resource from the lowest-priority virtual machine despite the computed allocation according to resource usage for example, in the event that resource usage by a process group exceeds a threshold value for such process group. Reallocation of resources from the lowest-priority virtual machine process group that is currently allocable can occur even if the current virtual machine process group has already exceeded the resource usage upper limit threshold value for the virtual machine (or the virtual machine process group). In some embodiments, a warning signal (e.g., a warning notification) may further be issued (e.g., communicated) for the purpose of instructing the upper-layer control system to activate live migration or another such strategy.

In some embodiments, if it is discovered (e.g., determined) that both (or all, as applicable) the host process groups and the virtual machine process groups have exceeded their corresponding preset resource usage upper threshold values, then resource allocation for the virtual machine process groups may be suspended in order to give priority assurance to resource use by the host process groups (and resources can be correspondingly reallocated to the host process groups).

Please note that all the method embodiments have been presented as a series of a combination of actions in order to simplify description. However, persons skilled in the art should know that embodiments of the present application are not limited by the action sequences that are described, for some of the steps may make use of another sequence or be implemented simultaneously in accordance with embodiments of the present application. Secondly, persons skilled in the art should also know that the embodiments described in the description are all preferred embodiments. The actions that they involve are not required by embodiments of the present application.

FIG. 3 is a structural block diagram of a device for server resource adjustment according to various embodiments of the present application.

Referring to FIG. 3, device 300 for resource adjustment is provided. Device 300 can implement process 100 of FIG. 1, or process 200 of FIG. 2. Device 300 can implement, or be implemented by, system 400 of FIG. 4 and/or computer system 500 of FIG. 5.

As illustrated in FIG. 3, device 300 comprises a collecting module 310, a computing module 320, a comparing module 330, and an adjusting module 340.

The collecting module 310 is configured to obtain resource usage information. The collecting module 310 can obtain first resource usage information associated with a first host computing system and second resource usage information associated with a second host computing system or a virtual machine. The collecting module 310 can obtain the corresponding resource usage information according to a preset sampling frequency. In some embodiments, the preset sampling frequency according to which the collecting module 310 obtains the first resource usage information can be the same as the preset sampling frequency according to which the collecting module 310 obtains the second resource usage information. In some embodiments, the preset sampling frequency according to which the collecting module 310 obtains the first resource usage information can be different from the preset sampling frequency according to which the collecting module 310 obtains the second resource usage information. The collecting module 310 can obtain the resource usage information by running one or more background programs on the server (e.g., on the hosts or virtual machines).

The collecting module 310 can be configured to perform 110 of process 100 of FIG. 1, and/or 210 of process 200 of FIG. 2.

The computing module 320 is configured to compute one or more characteristic values based at least in part on the resource usage information. The one or more characteristic values can be computed according to preset adjustment frequencies. For example, the computing module 320 computes a first characteristic value and a second characteristic value. In some embodiments, the first characteristic value is computed based at least in part on resource usage information associated with the host, and the second characteristic value is computed based at least in part on resource usage information associated with the virtual machine. The first characteristic value and/or the second characteristic value can be computed according to a preset adjustment frequency or a preset adjustment time interval. In some embodiments, the preset adjustment frequency is lower than the preset sampling frequency.

The computing module 320 can be configured to perform 120 of process 100 of FIG. 1, and/or 220 of process 200 of FIG. 2.

The comparing module 330 is configured to compare at least one of the one or more characteristic values to one or more corresponding resource usage threshold values. In some embodiments, the first characteristic value is compared to a first resource usage threshold value, and the second characteristic value is compared to a second resource usage threshold value. A first comparison result can be obtained (e.g., determined) based on the comparison of the first characteristic value with the first resource usage threshold value. The second resource usage threshold value can correspond to a preset resource usage threshold value associated with the virtual machine. A second comparison result can be obtained (e.g., determined) based on the comparison of the second characteristic value with the second resource usage threshold value.

The comparing module 330 can be configured to perform 130 of process 100 of FIG. 1, and/or 230 of process 200 of FIG. 2.

The adjusting module 340 is configured to adjust resource allocations associated with one or more hosts or virtual machines. Resource allocations that can be adjusted can include CPU processing or memory allocations, bandwidth, storage, or the like. The resource allocations associated with the one or more hosts are respectively adjusted based at least in part on the comparison of the one or more characteristic values to the one or more resource usage threshold values. For example, the resource allocations for the first host computing system and/or second host computing system or the virtual machine can be adjusted based at least in part on the first comparison result and/or the second comparison result. The adjusting module 340 can save the adjusted resource allocations to a local storage or to a remote storage to which the device 300 is connected via a network.

The adjusting module 340 can be configured to perform 140 of process 100 of FIG. 1, and/or 240 of process 200 of FIG. 2.

As an illustrative example of a specific application of an embodiment of the present application, the server may be a KVM server, the first host computing system may be a host computer, and the second host computing system may be a virtual machine.

In some embodiments, the first resource usage information associated with the first host computing system comprises resource use data for host process groups, and the second resource usage information associated with the second host computing system comprises resource use data for virtual machine process groups. The host process groups can comprise the relevant process groups that provide services to all the virtual machines and the virtual machine process groups are process groups for the virtual machine itself.

In some embodiments, the first characteristic value is a sliding average of the computer resource usage information for the host, and the second characteristic value is a sliding average of the collected resource usage information for the virtual machine.

In some embodiments, the resource usage threshold value for the host corresponds to a host resource usage upper threshold value, and the resource usage threshold value for the virtual machine corresponds to a virtual machine resource usage upper threshold value. In this case, the adjusting module 340 comprises one or more of a first adjusting submodule 341 or a second adjusting submodule 342.

The first adjusting submodule 341 is configured to, when the first comparison result corresponds to a first characteristic value being less than the resource usage upper threshold value for the host, and the second comparison result corresponds to the second characteristic value being less than the resource usage upper threshold value for the virtual machine, and if a first characteristic parameter is n times the smallest unit of resource usage less than the second characteristic parameter, then set the smallest unit resource usage by multiplying by (n/2+1) for the virtual machine process groups and the smallest unit resource usage by dividing by (n/2+1) for host process groups.

The smallest unit of resource usage can correspond to a smallest indivisible resource adjustment unit.

The second adjusting submodule 342 is configured to, when the first comparison result corresponds to the first characteristic value being less than the resource usage upper threshold value for the host, and the second comparison result corresponds to the second characteristic value being less than the virtual machine resource usage upper threshold value for the virtual machine, and if a second characteristic parameter is less than a first characteristic parameter by n times the smallest unit resource usage, then set the smallest unit resource usage by dividing by (n/2+1) for the virtual machine process groups and the smallest unit resource usage by multiplying by (n/2+1) for the host process groups, wherein n is an integer and n/2 is rounded.

According to various embodiments, the adjusting module 340 comprises a third adjusting submodule 343 and a mutually exclusive group allocating submodule 344.

The third adjusting submodule 343 is configured to, in the event that the first comparison result corresponds to the first characteristic value being greater than or equal to the resource usage upper threshold value for the host, and/or the second comparison result corresponds to the second characteristic value being greater than or equal to the resource usage upper threshold value for the virtual machine, extract mutually exclusive virtual machine process groups and host computer process groups.

The mutually exclusive group allocating submodule 344 is configured to allocate resources from the mutually exclusive virtual machine process groups and host computer process groups.

In some embodiments, the virtual machine process groups and host computer process groups have respective priority levels. In this case, the adjusting module 340 comprises a group determining submodule 345 or a seizing submodule 346. In some embodiments, the mutually exclusive group allocation submodule can comprise the group determining submodule 345 or the seizing submodule 346.

The group determining submodule 345 is configured to determine the lowest-priority level virtual machine process groups or host computer process groups that can be allocated from among the mutually exclusive virtual machine process groups and host process groups.

The seizing submodule 346 is configured to seize the virtual machine process groups or host process groups for resource allocation.

In some embodiments, the adjusting module 340 comprises a warning submodule (not shown). The warning submodule is configured to issue (communicate) an advance warning signal, the advance warning signal instructing the upper level control system to carry out live migration accordingly.

In some embodiments, the adjusting module 340 comprises a fourth adjusting submodule (not shown). The fourth adjusting submodule is configured to, in the event that the first comparison result corresponds to a characteristic value being greater than or equal to the resource usage upper threshold value for the host, and the second comparison result corresponds to a second characteristic value being greater than or equal to the resource usage upper threshold value for the virtual machine, suspend (or seize) virtual machine process group resource allocation and maintain host computer process group resource allocation.

Because the device embodiments are basically similar to the method embodiments, they are described in simpler terms. Refer to the corresponding section in a method embodiment as necessary.

FIG. 4 is a structural schematic diagram for server resource adjustment according to various embodiments of the present disclosure.

Referring to FIG. 4, system 400 can be implemented in connection with process 100 of FIG. 1 or process 200 of FIG. 2. System 400 can implement device 300 of FIG. 3. System 400 can be implemented in connection with computer system 500 of FIG. 5.

As illustrated in FIG. 4, system 400 can comprise a terminal 410 and a server 420. System 400 can further comprise a network 430 over which terminal 410 and server 420 communicate. A user can access the server 420 via the terminal. For example, the server 420 can provide an application or service to the terminal 410. The application or service provided by the server 420 can be a business application or software as a service.

In some embodiments, system 400 can further comprise one or more of host 422, host 424, virtual machine 426, or virtual machine 428. Server 420 can comprise host 422, host 424, virtual machine 426, or virtual machine 428. In some embodiments, system 400 comprises host 440 or virtual machine 450. Host 440 or virtual machine 450 can communicate with server 420 and/or terminal 410 via network 430.

FIG. 5 is a functional diagram of a computer system for server resource adjustment according to various embodiments of the present disclosure.

Referring to FIG. 5, a computer system 500 for resource adjustment is shown. As will be apparent, other computer system architectures and configurations can be used to detect a specified identifier. Computer system 500, which includes various subsystems as described below, includes at least one microprocessor subsystem (also referred to as a processor or a central processing unit (CPU)) 502. For example, processor 502 can be implemented by a single-chip processor or by multiple processors. In some embodiments, processor 502 is a general purpose digital processor that controls the operation of the computer system 500. Using instructions retrieved from memory 510, the processor 502 controls the reception and manipulation of input data, and the output and display of data on output devices (e.g., display 518).

Processor 502 is coupled bi-directionally with memory 510, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 502. Also as is well known in the art, primary storage typically includes basic operating instructions, program code, data, and objects used by the processor 502 to perform its functions (e.g., programmed instructions). For example, memory 510 can include any suitable computer-readable storage media, described below, depending on whether, for example, data access needs to be bi-directional or uni-directional. For example, processor 502 can also directly and very rapidly retrieve and store frequently needed data in a cache memory (not shown). The memory can be a non-transitory computer-readable storage medium.

A removable mass storage device 512 provides additional data storage capacity for the computer system 500, and is coupled either bi-directionally (read/write) or uni-directionally (read only) to processor 502. For example, storage 512 can also include computer-readable media such as magnetic tape, flash memory, PC-CARDS, portable mass storage devices, holographic storage devices, and other storage devices. A fixed mass storage 520 can also, for example, provide additional data storage capacity. The most common example of mass storage 520 is a hard disk drive. Mass storage device 512 and fixed mass storage 520 generally store additional programming instructions, data, and the like that typically are not in active use by the processor 502. It will be appreciated that the information retained within mass storage device 512 and fixed mass storage 520 can be incorporated, if needed, in standard fashion as part of memory 510 (e.g., RAM) as virtual memory.

In addition to providing processor 502 access to storage subsystems, bus 514 can also be used to provide access to other subsystems and devices. As shown, these can include a display monitor 518, a network interface 516, a keyboard 504, and a pointing device 506, as well as an auxiliary input/output device interface, a sound card, speakers, and other subsystems as needed. For example, the pointing device 506 can be a mouse, stylus, track ball, or tablet, and is useful for interacting with a graphical user interface.

The network interface 516 allows processor 502 to be coupled to another computer, computer network, or telecommunications network using a network connection as shown. For example, through the network interface 516, the processor 502 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 502 can be used to connect the computer system 500 to an external network and transfer data according to standard protocols. For example, various process embodiments disclosed herein can be executed on processor 502, or can be performed across a network such as the Internet, intranet networks, or local area networks, in conjunction with a remote processor that shares a portion of the processing. Additional mass storage devices (not shown) can also be connected to processor 502 through network interface 516.

An auxiliary I/O device interface (not shown) can be used in conjunction with computer system 500. The auxiliary I/O device interface can include general and customized interfaces that allow the processor 502 to send and, more typically, receive data from other devices such as microphones, touch-sensitive displays, transducer card readers, tape readers, voice or handwriting recognizers, biometrics readers, cameras, portable mass storage devices, and other computers.

The computer system shown in FIG. 5 is but an example of a computer system suitable for use with the various embodiments disclosed herein. Other computer systems suitable for such use can include additional or fewer subsystems. In addition, bus 514 is illustrative of any interconnection scheme serving to link the subsystems. Other computer architectures having different configurations of subsystems can also be utilized.

The modules described as separate components may or may not be physically separate, and components displayed as modules may or may not be physical modules. They can be located in one place, or they can be distributed across multiple network modules. The embodiment schemes of the present embodiments can be realized by selecting part or all of the modules in accordance with actual need.

Furthermore, the functional modules in the various embodiments of the present invention can be integrated into one processor, or each module can have an independent physical existence, or two or more modules can be integrated into a single module. The aforesaid integrated modules can take the form of hardware, or they can take the form of hardware combined with software function modules.

Each of the embodiments contained in this description is described in a progressive manner, the explanation of each embodiment focuses on areas of difference from the other embodiments, and the descriptions thereof may be mutually referenced for portions of each embodiment that are identical or similar.

A person skilled in the art should understand that an embodiment of the present application may provide methods, devices, or computer program products. Therefore, the embodiments of the present application may take the form of embodiments that are entirely hardware, embodiments that are entirely software, and embodiments that combine hardware and software aspects. Moreover, embodiments of the present application may employ one or more forms of computer products that implement computer-operable storage media (including but not limited to magnetic disk storage devices, CD-ROMs, and optical storage devices) containing computer-operable computer code.

In one typical configuration, said computer equipment comprises one or more processors (CPUs), input/output interfaces, network interfaces, and memory. Memory may include such forms as volatile memory in computer-readable media, random access memory (RAM), and/or non-volatile memory, such as read-only memory (ROM) or flash memory (flash RAM). Memory is an example of a computer-readable medium. Computer-readable media, including permanent and non-permanent and removable and non-removable media, may achieve information storage by any method or technology. Information can be computer-readable commands, data structures, program modules, or other data. Examples of computer storage media include but are not limited to phase-change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disk read-only memory (CD-ROM), digit multifunction disc (DVD) or other optical storage, magnetic cassettes, magnetic tape or magnetic disc storage, or other magnetic storage equipment or any other non-transmission media that can be used to store information that is accessible to computers. As defined in this document, computer-readable media does not include transitory computer-readable media, (transitory media), such as modulated data signals and carrier waves.

The embodiments of the present application are described with reference to flowcharts and/or block diagrams based on methods, systems, and computer program products of the embodiments of the present application. Please note that each flowchart and/or block diagram within the flowcharts and/or block diagrams and combinations of flowcharts and/or block diagrams within the flowcharts and/or block diagrams can be realized by computer commands. These computer program commands can be provided to the processors of general-purpose computers, specialized computers, embedded processor devices, or other programmable data-processing terminals to produce a machine. The commands executed by the processors of the computers or other programmable data-processing terminal equipment consequently give rise to devices for implementing the functions specified in one or more processes in the flowcharts and/or one or more blocks in the block diagrams.

These computer program commands can also be stored in computer-readable memory that can guide the computers or other programmable data-processing terminal equipment to operate in a specific manner. As a result, the commands stored in the computer-readable memory give rise to products including command devices. These command devices implement the functions specified in one or more processes in the flowcharts and/or one or more blocks in the block diagrams.

These computer program commands can also be loaded onto computers or other programmable data-processing terminal equipment and made to execute a series of steps on the computers or other programmable data-processing terminal equipment so as to give rise to computer-implemented processing. The commands executed on the computers or other programmable data-processing terminal equipment thereby provide the steps of the functions specified in one or more processes in the flowcharts and/or one or more blocks in the block diagrams.

Although preferred embodiments of the present application have already been described, a person skilled in the art can make other modifications or revisions to these embodiments once they grasp the basic creative concept. Therefore, the attached claims are to be interpreted as including the preferred embodiments as well as all modifications and revisions falling within the scope of the embodiments of the present application.

Lastly, it must also be explained that, in this document, relational terms such as “first” or “second” are used only to differentiate between one entity or operation and another entity or operation, without necessitating or implying that there is any such actual relationship or sequence between these entities or operations. Moreover, the term “comprise” or “contain” or any of their variants are to be taken in their non-exclusive sense. Thus, processes, methods, things, or terminal devices that comprise a series of elements not only comprise those elements, but also comprise other elements that have not been explicitly listed or elements that are intrinsic to such processes, methods, things, or terminal devices. In the absence of further limitations, elements that are limited by the phrase “comprises a(n) . . . ” do not exclude the existence of additional identical elements in processes, methods, things, or terminal devices that comprise said elements.

A server resource adjustment method and a server resource adjustment device, which are provided by the present application, have been described in detail above. This document has employed specific embodiments to expound the principles and forms of implementation of the present application. The above embodiment explanations are only meant to aid in comprehension of the methods of the present application and of its core concepts. Moreover, a person with general skill in the art would, on the basis of the concepts of the present application, be able to make modifications to specific forms of implementation and to the scope of applications. To summarize the above, the contents of this description should not be understood as limiting the present application.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for adjusting resources of a server comprising a first host computing system and a second host computing system, the method comprising:
obtaining first resource usage information associated with the first host computing system and second resource usage information associated with the second host computing system, the first resource usage information and the second resource usage information being obtained according to a preset sampling frequency;
computing a first characteristic value and a second characteristic value according to a preset adjustment frequency, wherein the first characteristic value is computed based at least in part on the first resource usage information, the second characteristic value is computed based at least in part on the second resource usage information, and the preset adjustment frequency is lower than the preset sampling frequency;
obtaining a first comparison result based on comparing the first characteristic value to a resource usage threshold value of the first host computing system, and a second comparison result based on comparing the second characteristic value to a resource usage threshold value of the second host computing system; and
adjusting resource allocations for at least one of the first host computing system or the second host computing system based at least in part on the first comparison result or the second comparison result.

2. The method of claim 1, wherein computing the first characteristic value and the second characteristic value according to the preset adjustment frequency comprises:
computing a sliding average of the first resource usage information and a sliding average of the second resource usage information according to the preset adjustment frequency.

3. The method of claim 1, wherein the server is a Kernel-based Virtual Machine (KVM) server, the first host computing system is a host computer, and the second host computing system is one or more virtual machines.

4. The method of claim 3, wherein the first resource usage information comprises resource use data for one or more host process groups, the second resource usage information comprises resource use data for one or more virtual machine process groups, the one or more host process groups comprise relevant process groups that provide services to the one or more virtual machines, and the one or more virtual machine process groups are process groups of the virtual machines.

5. The method of claim 4, wherein obtaining the first resource usage information associated with the first host computing system and the second resource usage information associated with the second host computing system comprises:
obtaining from designated files of the resource use data for the host process groups and the resource use data for the virtual machine process groups according to the preset sampling frequency, wherein the designated files comprise process statistics data.

6. The method of claim 5, wherein:
the resource usage threshold value of the first host computing system is an upper threshold value for resource usage of the first host computing system and the resource usage threshold value of the second host computing system is an upper threshold value for resource usage of the virtual machines; and
adjusting resource allocations for the host or the virtual machines based at least in part on the first comparison result or the second comparison result comprises:
in the event that the first comparison result that corresponds to the first characteristic value is less than the resource usage upper threshold value of the host, and the second comparison result that corresponds to the second characteristic value is less than the resource usage upper threshold value of the virtual machines:
setting a smallest unit resource usage for the virtual machine process groups according to (B/A+B)*S and a smallest unit resource for the host process groups according to (A/A+B)*S, where A, B, and S are integers, and A corresponds to the first characteristic value, B corresponds to the second characteristics value, and S corresponds to the available resources.

7. The method of claim 6, wherein the adjusting resource allocations for at least one of the first host computing system or the second host computing system based at least in part on the first comparison result or the second comparison result further comprises:
in the event that at least one of the first comparison result that corresponds to the first characteristic value at least meets the resource usage upper threshold value of the host, or the second comparison result that corresponds to the second characteristic value at least meets the resource usage upper threshold value of the virtual machines, extracting mutually exclusive virtual machine process groups and host process groups; and
allocating resources from the mutually exclusive virtual machine process groups and host process groups.

8. The method of claim 7, wherein the virtual machine process groups and the host process groups have corresponding respective priority levels, and the allocating resources from the mutually exclusive virtual machine groups and host groups comprises:
determining a lowest-priority level virtual machine process groups or host process groups that can be allocated from among the mutually exclusive virtual machine process groups and host process groups; and
seizing the virtual machine process groups or host process groups for resource allocation.

9. The method of claim 8, wherein the seizing the virtual machine process groups or host process groups for resource allocation comprises obtaining the lowest-priority level virtual machine process groups or host process groups for resource allocation.

10. The method of claim 4, wherein the adjusting resource allocations for at least one of the first host computing system or the second host computing system based at least in part on the first comparison result or the second comparison result comprises:
issuing an advance warning signal, the advance warning signal instructing an upper level control system to carry out live migration accordingly.

11. The method of claim 4, wherein adjusting resource allocations for at least one of the first host computing system or the second host computing system based at least in part on the first comparison result or the second comparison result comprises:
in the event that the first comparison result that corresponds to the first characteristic value at least meets a resource usage upper threshold value of the host, and the second comparison result that corresponds to the second characteristic value at least meets a resource usage upper threshold value of the virtual machines, suspending virtual machine process group resource allocation and maintaining host process group resource allocation.

12. A server, comprising a first host computing system and a second host computing system, and further comprising:
one or more processors configured to:
obtain first resource usage information associated with the first host computing system and second resource usage information associated with the second host computing system, the first resource usage information and the second resource usage information being obtained according to a preset sampling frequency;
compute a first characteristic value and a second characteristic value according to a preset adjustment frequency, wherein the first characteristic value is computed based at least in part on the first resource usage information, the second characteristic value is computed based at least in part on the second resource usage information, and the preset adjustment frequency is lower than the preset sampling frequency;
obtain a first comparison result based on comparing the first characteristic value to a resource usage threshold value of the first host computing system, and a second comparison result based on comparing the second characteristic value to a resource usage threshold value of the second host computing system; and
adjust resource allocations for at least one of the first host computing system or the second host computing system based at least in part on the first comparison result or the second comparison result; and
a memory coupled to the one or more processors and configured to provide the one or more processors with instructions.

13. The device of claim 12, characterized in that said server is a Kernel-based Virtual Machine (KVM) server, the first host computing system is a host computer, and the second host computing system is one or more virtual machines.

14. The device of claim 13, wherein the first resource usage information comprises resource use data for host process groups, the second resource usage information comprises resource use data for virtual machine process groups, the host process groups comprise relevant process groups that provide services to the one or more virtual machines, and the virtual machine process groups are process groups of the virtual machines.

15. The device as described of claim 14, wherein the first characteristic value is a sliding average of the first resource usage information, and the second characteristic value is a sliding average of the second resource usage information.

16. The device of claim 15, wherein:
resource usage threshold value of the first host computing system is an upper threshold value for resource usage of the first host computing system and the resource usage threshold value of the second host computing system is an upper threshold value for resource usage of the virtual machines; and
the one or more processors are further configured to, in the event that the first comparison result that corresponds to the first characteristic value is less than the resource usage upper threshold value of the host, and the second comparison result that corresponds to the second characteristic value is less than the resource usage upper threshold value of the virtual machines:
setting a smallest unit resource usage for the virtual machine process groups according to (B/A+B)*S and a smallest unit resource for the host process groups according to (A/A+B)*S, where A, B, and S are integers, and A corresponds to the first characteristic value, B corresponds to the second characteristics value, and S corresponds to the available resources.

17. The device of claim 16, wherein the one or more processors are further configured to:
in the event that at least one of the first comparison result that corresponds to the first characteristic value is greater than or equal to the resource usage upper threshold value of the host, or the second comparison result that corresponds to the second characteristic value is greater than or equal to the resource usage upper threshold value of the virtual machine, extract mutually exclusive virtual machine process groups and host process groups; and
allocate resources from the mutually exclusive virtual machine process groups and host process groups.

18. The device of 17, wherein the one or more processors are further configured to:
determine a lowest-priority level virtual machine process groups or host process groups that can be allocated from among the mutually exclusive virtual machine process groups and host process groups; and
seize the virtual machine process groups or host process groups for resource allocation.

19. The device of claim 18, wherein to seize the virtual machine process groups or host process groups for resource allocation comprises obtaining the lowest-priority level virtual machine process groups or host process groups for resource allocation.

20. The device of claim 16, wherein the one or more processors are further configured to:
issue an advance warning signal, the advance warning signal instructing an upper level control system to carry out live migration accordingly.

21. The device of claim 16, wherein the one or more processors are further configured to:
in the event that the first comparison result that corresponds to the first characteristic value is greater than or equal to the resource usage upper threshold value of the host, and the second comparison result that corresponds to the second characteristic value is greater than or equal to the resource usage upper threshold value of the virtual machines, suspend virtual machine process group resource allocation and maintain host process group resource allocation.

22. A computer program product, the computer program product being embodied in a non-transitory computer readable storage medium and comprising computer instructions for:
obtaining first resource usage information associated with a first host computing system and second resource usage information associated with a second host computing system, the first resource usage information and the second resource usage information being obtained according to a preset sampling frequency;
computing a first characteristic value and a second characteristic value according to a preset adjustment frequency, wherein the first characteristic value is computed based at least in part on the first resource usage information, the second characteristic value is computed based at least in part on the second resource usage information, and the preset adjustment frequency is lower than the preset sampling frequency;
obtaining a first comparison result based on comparing the first characteristic value to a resource usage threshold value of the first host computing system, and a second comparison result based on comparing the second characteristic value to a resource usage threshold value of the second host computing system; and
adjusting resource allocations for at least one of the first host computing system or the second host computing system based at least in part on the first comparison result or the second comparison result.
